(19) United States
(12) Patent Application Publication
(10) Pub. No.: US 2025/0303349 A1
(43) Pub. Date: Oct. 2, 2025

(54) CARBON DIOXIDE RECOVERY APPARATUS

(71) Applicant: HONDA MOTOR CO., LTD., Tokyo (JP)

(72) Inventors: Subaru MATSUMOTO, Saitama (JP); Masanobu TAKAZAWA, Saitama (JP)

(21) Appl. No.: 19/063,347

(22) Filed: Feb. 26, 2025

(30) Foreign Application Priority Data
Mar. 27, 2024 (JP) 2024-051688

(51) Int. Cl. B01D 53/04

(52) U.S. Cl. CPC B01D 53/0462; B01D 53/0438; B01D 2253/20; B01D 2257/504; B01D 2259/41

(57) ABSTRACT

Provided is a carbon dioxide recovery apparatus that reduces an energy loss to a low level, while preventing or reducing deterioration of an adsorbent that can be caused by a heat transfer medium compressed by a compressor. In a carbon dioxide recovery apparatus, a heat transfer medium decompressed by an expansion valve is supplied to a first reactor that performs an adsorption process so that heat exchange between the heat transfer medium and the first reactor cools an adsorbent and heats the heat transfer medium, and the heat transfer medium compressed by a compressor is cooled by a heat exchanger and then supplied to a portion which belongs to a second reactor that performs a desorption process and in which an adsorbent is cooled so that heat exchange between the heat transfer medium and the second reactor heats the adsorbent and cools the heat transfer medium.

This application is based on and claims the benefit of priority from Japanese Patent Application No. 2024-051688, filed on 27 Mar. 2024, the content of which is incorporated herein by reference.

### BACKGROUND OF THE INVENTION

### Field of the Invention

The present invention relates to a carbon dioxide recovery apparatus.

### Related Art

There is a known carbon dioxide recovery apparatus in which a carbon dioxide-containing gas, such as air, is suctioned into a reactor that holds an adsorbent so that the adsorbent adsorbs carbon dioxide, thereby recovering carbon dioxide. This type of technique is described, for example, in Japanese Unexamined Patent Application, Publication No. 2022-152077. Specifically, Japanese Unexamined Patent Application, Publication No. 2022-152077 relates to a CO₂ separation device that is adapted for an internal combustion engine and desorbs CO₂ adsorbed on a CO₂ adsorbent by raising the temperature of the CO₂ adsorbent without requiring external supply of thermal energy.
Patent Document 1: Japanese Unexamined Patent Application, Publication No. 2022-152077

### SUMMARY OF THE INVENTION

Some carbon dioxide recovery apparatuses heat or cool an adsorbent using a heat transfer medium such as a long life coolant (LLC) heated or cooled by a heat pump. The LLC is heated and cooled by means of another heat transfer medium, such as a fluorocarbon gas, flowing in the heat pump. Thus, from the viewpoint of the whole apparatus, the adsorbent is supplied with heat energy through two kinds of heat transfer mediums.

In such a case where two types of heat transfer mediums are used, the loss caused by heat exchange increases accordingly. It is conceivable to directly heat or cool an adsorbent with a heat transfer medium such as a fluorocarbon gas without using a heat transfer medium such as an LLC. However, since a heat transfer medium for a heat pump, such as a fluorocarbon gas, is heated to a superheated state by being compressed, if the superheated heat transfer medium is directly supplied to a reactor, the temperature of the reactor will become higher than necessary, which may cause deterioration of the adsorbent.

It is an object of the present invention to provide a carbon dioxide recovery apparatus that reduces an energy loss to a low level, while preventing or reducing deterioration of an adsorbent that can be caused by a heat transfer medium compressed by a compressor.

A first aspect of the present invention is directed to a carbon dioxide recovery apparatus (e.g., a carbon dioxide recovery apparatus 1 to be described later) including: a plurality of reactors (e.g., a first reactor 11a and a second reactor 11b to be described later) each of which includes an adsorbent (e.g., an adsorbent 12 to be described later) therein, the plurality of reactors being configured to perform an adsorption process in which a gas containing carbon dioxide is suctioned and the carbon dioxide is adsorbed on the adsorbent, and a desorption process in which surroundings of the adsorbent are heated in a decompressed state whereby the carbon dioxide is desorbed from the adsorbent; an expansion valve (e.g., an expansion valve 71, a first expansion valve 71a, and a second expansion valve 71b to be described later) that expands and decompresses a heat transfer medium to be supplied for a cooling purpose to one of the plurality of reactors that performs the adsorption process; a compressor (e.g., a compressor 72 to be described alter) that compresses and pressurizes the heat transfer medium to be supplied for a heating process to an other of the plurality of reactors that performs the desorption process; and a heat exchanger (e.g., a heat exchanger 75 and a heat exchanger 75a to be described later) that cools the heat transfer medium compressed by the compressor. The heat transfer medium decompressed by the expansion valve is supplied to the one of the plurality of reactors that performs the adsorption process so that heat exchange between the heat transfer medium and the one of the plurality of the reactors cools the adsorbent and heats the heat transfer medium, and the heat transfer medium compressed by the compressor is cooled by the heat exchanger and then supplied to a portion which belongs to the other of the plurality of reactors that performs the desorption process and in which the adsorbent is cooled so that heat exchange between the heat transfer medium and the other of the plurality of reactors heats the adsorbent and cools the heat transfer medium.

According to a second aspect of the present invention, in the carbon dioxide recovery apparatus of the first aspect, the heat exchanger may exchange heat between the heat transfer medium that has been compressed by the compressor and is yet to enter the other of the plurality of reactors that performs the desorption process and the heat transfer medium that has passed through the other of the plurality of reactors that performs the desorption process.

According to a third aspect of the present invention, in the carbon dioxide recovery apparatus of the first aspect, the heat exchanger (e.g., a heat exchanger 75a to be described later) may exchange heat between the heat transfer medium that has been compressed by the compressor and is yet to enter the other of the plurality of reactors that performs the desorption process, and the heat transfer medium that is passing through a flow path (e.g., a flow path 76 to be described later) for the heat transfer medium inside the reactor.

According to a fourth aspect of the present invention, in the carbon dioxide recovery apparatus of the third aspect, the flow path for the heat transfer medium inside the reactor includes an odd total number of passes (e.g., a first pass 81, a second pass 82, and a third pass 83 to be described later) connected to each other in a meandering pattern, and the heat exchanger exchanges heat between the heat transfer medium that has passed through one (e.g., the second pass 82 to be described later) of the passes that is located immediately before a final pass (e.g., the third pass 83 to be described later) of the passes, and the heat transfer medium that has been compressed by the compressor.

The present invention provides a carbon dioxide recovery apparatus that reduces an energy loss to a low level, while preventing or reducing deterioration of an adsorbent that can be caused by a heat transfer medium compressed by a compressor.

### BRIEF DESCRIPTION OF THE DRAWINGS

FIG. 1 is a schematic diagram illustrating a configuration of a carbon dioxide recovery apparatus according to a first embodiment;

FIG. 2 is a circuit diagram illustrating a heat exchange device of the carbon dioxide recovery apparatus according to the first embodiment;

FIG. 3 is a Mollier diagram illustrating heat transfer in the heat exchange device of the carbon dioxide recovery apparatus according to the first embodiment;

FIG. 4 is a circuit diagram illustrating a heat exchange device of a carbon dioxide recovery apparatus according to a second embodiment;

FIG. 5 is a Mollier diagram illustrating heat transfer in the heat exchange device of the carbon dioxide recovery apparatus according to the second embodiment;

FIG. 6 is a schematic diagram illustrating flow paths for a heat transfer medium in a reactor of a carbon dioxide recovery apparatus according to a third embodiment;

FIG. 7 is a diagram illustrating a configuration example of a fourth embodiment in which a pass formed inside each reactor has a single-path configuration; and

FIG. 8 is a diagram illustrating the configuration example of the fourth embodiment in which the pass formed inside each reactor has a single-path configuration.

### DETAILED DESCRIPTION OF THE INVENTION

Embodiments of the present invention will be described with reference to the drawings.

### First Embodiment

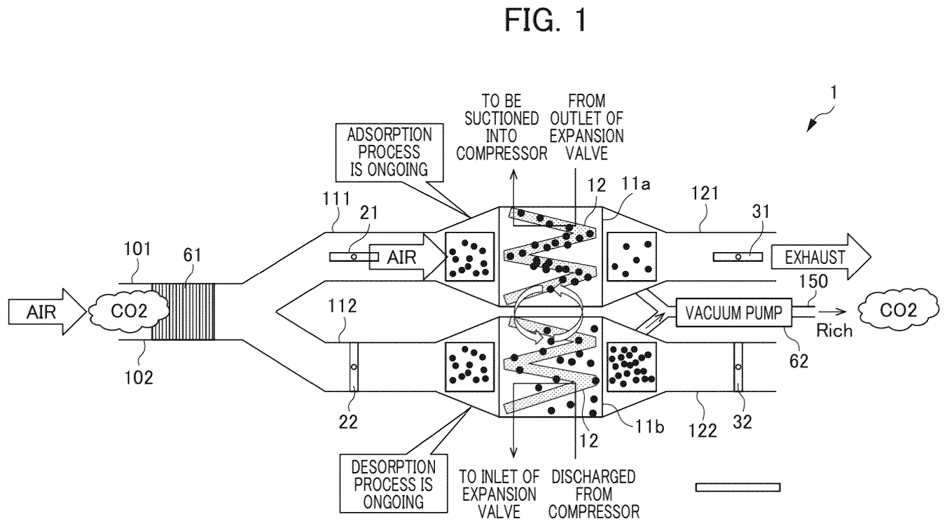

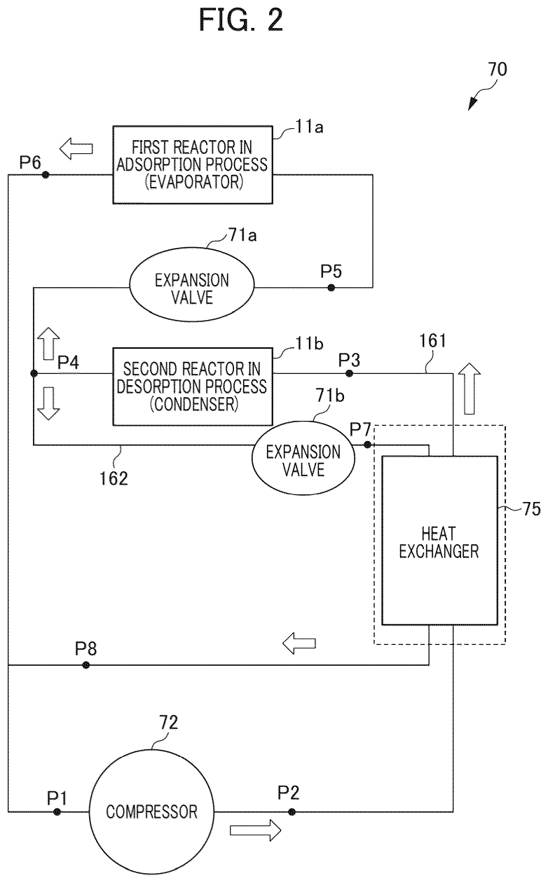

FIG. 1 is a schematic diagram illustrating a configuration of a carbon dioxide recovery apparatus 1 according to a first embodiment. FIG. 2 is a circuit diagram illustrating a heat exchange device 70 of the carbon dioxide recovery apparatus 1 according to the first embodiment.

The carbon dioxide recovery apparatus 1 is applicable to, for example, a direct air capture (DAC) technique for recovering carbon dioxide from atmospheric air in order to reduce the concentration of carbon dioxide in atmospheric air. The carbon dioxide recovered by the carbon dioxide recovery apparatus 1 is stored underground or reused as a fuel or a material.

As illustrated in FIGS. 1 and 2, the carbon dioxide recovery apparatus 1 includes a first reactor 11a, a second reactor 11b, an atmospheric air suction line 101, a blower 61, a first intake on-off valve 21, a second intake on-off valve 22, a first exhaust line 121, a first exhaust on-off valve 31, a second exhaust line 122, a second exhaust on-off valve 32, a carbon dioxide line 150, a vacuum pump 62, and a heat exchange device 70. In FIG. 1, the heat exchange device 70 is not shown.

Each of the first reactor 11a and the second reactor 11b includes therein an adsorbent 12 for adsorbing carbon dioxide. Each adsorbent 12 is a particulate member and has a property of adsorbing carbon dioxide in a state in which the adsorbent 12 is at a low temperature (e.g., in the range of −30° C. to 50° C.), and a property of desorbing (releasing) carbon dioxide in a state in which the adsorbent 12 is at a high temperature (e.g., in the range of 50° C. to 110° C.) and the surroundings have a low concentration of carbon dioxide. An example of the adsorbent 12 includes, but is not limited to, a solid amine carbon dioxide adsorbent constituted by a porous material such as silica and an amine supported thereon.

The first reactor 11a and the second reactor 11b alternately perform an adsorption process in which the adsorbent 12 adsorbs carbon dioxide from a gas such as suctioned atmospheric air or the like, and a desorption process in which the carbon dioxide adsorbed on the adsorbent 12 is desorbed by way of decompression-heating after generating a vacuum. In the example illustrated in FIG. 1, the adsorption process is being performed in the first reactor 11a, while the desorption process is being performed in the second reactor 11b.

The atmospheric air suction line 101 is a pipe through which a carbon dioxide-containing gas, such as atmospheric air, suctioned from a suction port 102 is sent to the first reactor 11a or the second reactor 11b. The atmospheric air suction line 101 has a first branch line 111 that branches to connect to an upstream side of the first reactor 11a and a second branch line 112 that branches to connect to an upstream side of the second reactor 11b.

The blower 61 is disposed in the atmospheric air suction line 101 in a portion upstream of the branch portion where the first branch line 111 and the second branch line 112 branch off. The blower 61 is driven to generate, through the atmospheric air suction line 101, a gas flow from “intake” to “exhaust” with respect to the first reactor 11a or the second reactor 11b. In this way, the carbon dioxide-containing gas is supplied to the inside of the first reactor 11a or the second reactor 11b.

The first intake on-off valve 21 is disposed in the first branch line 111. The first intake on-off valve 21 is controlled to be in an open state in which the path of the first branch line 111 is open during the adsorption process, and is controlled to be in a closed state in which the path of the first branch line 111 is closed during the desorption process. In the example illustrated FIG. 1, the first reactor 11a is performing the adsorption process, and accordingly, the first intake on-off valve 21 is controlled to be in the open state.

The second intake on-off valve 22 is disposed in the second branch line 112. The second intake on-off valve 22 is controlled to be in an open state in which the path of the second branch line 112 is open during the adsorption process, and is controlled to be in a closed state in which the path of the second branch line 112 is closed during in the desorption process. In the example illustrated FIG. 1, the second reactor 11b is performing the desorption process, and accordingly, the second intake on-off valve 22 is controlled to be in the closed state.

The first exhaust line 121 is a pipe connected to a downstream side of the first reactor 11a. The first exhaust on-off valve 31 is disposed in the first exhaust line 121. The first exhaust on-off valve 31 is controlled to be in an open state in which the path of the first exhaust line 121 is open during the adsorption process, and is controlled to be in a closed state in which the path of the first exhaust line 121 is closed during the desorption process. In the example illustrated FIG. 1, the first reactor 11a is performing the adsorption process, and accordingly, the first exhaust on-off valve 31 is controlled to be in the open state. During the adsorption process, the gas subjected to the adsorption process is discharged to the outside through the first exhaust line 121 even if the gas contains carbon dioxide.

The second exhaust line 122 is a pipe connected to a downstream side of the second reactor 11b. The second exhaust on-off valve 32 is disposed in the second exhaust line 122. The second exhaust on-off valve 32 is controlled to be in an open state in which the path of the second exhaust line 122 is open during the adsorption process, and is controlled to be in a closed state in which the path of the second exhaust line 122 is closed during the desorption process. In the example illustrated FIG. 1, the second reactor 11b is performing the desorption process, and accordingly, the second exhaust on-off valve 32 is controlled to be in the closed state.

The carbon dioxide line 150 is connected to the downstream side of the first reactor 11a and the downstream side of the second reactor 11b. The carbon dioxide line 150 is a pipe through which carbon dioxide desorbed in the desorption process is recovered, and allows a high concentration of carbon dioxide to flow therethrough.

The vacuum pump 62 is disposed in the carbon dioxide line 150. By driving the vacuum pump 62, the carbon dioxide desorbed in the desorption process performed in the first reactor 11a or the second reactor 11b is suctioned and recovered.

Next, a configuration of the heat exchange device 70 will be described with reference to FIG. 2. It should be noted that the flow paths in FIG. 2 are conceptual and indicate flows of a heat transfer medium, and the positions of the first reactor 11a and the second reactor 11b are switched in a state in which the first reactor 11a transitions to the desorption process and the second reactor 11b transitions to the adsorption process. As means for switching the flow paths, known techniques such as a branching pipe path and a flow path switching valve can be used.

As illustrated in FIG. 2, the heat exchange device 70 includes a first heat exchange line 161, a second heat exchange line 162, a first expansion valve 71a, a second expansion valve 71b, a compressor 72, a heat exchanger 75, the first reactor 11a, and the second reactor 11b.

The first heat exchange line 161 is a heat transfer medium flow path for supplying the heat transfer medium to the first reactor 11a and the second reactor 11b. The heat transfer medium is, for example, a fluorocarbon gas. On the first heat exchange line 161, the compressor 72, the heat exchanger 75, the second reactor 11b, the first expansion valve 71a, and the first reactor 11a are arranged in this order in an upstream-to-downstream direction. The first heat exchange line 161 is configured as a circulation flow path through which the heat transfer medium that has exited from an outlet of the compressor 72 finally returns to an inlet of the compressor 72.

The second heat exchange line 162 is a heat transfer medium flow path that branches off from a portion of the first heat exchange line 161 located downstream of the second reactor 11b and that connects to a portion of the first heat exchange line 161 located downstream of the first reactor 11a via the heat exchanger 75. On the second heat exchange line 162, the second expansion valve 71b and the heat exchanger 75 are arranged in this order in an upstream-to-downstream direction.

The first expansion valve 71a expands and decompresses the heat transfer medium to be supplied to the first reactor 11a that performs the adsorption process. As a result, the temperature of the heat transfer medium decreases. In the present embodiment, the heat transfer medium that has been cooled by performing heating in the second reactor 11b is expanded and decompressed by the first expansion valve 71a.

The second expansion valve 71b expands the heat transfer medium flowing through the second heat exchange line 162 after exiting from the second reactor 11b that performs the desorption process, and not the heat transfer medium flowing through the first heat exchange line 161 connected to the first expansion valve 71a. The heat transfer medium flowing through the second heat exchange line 162 is decompressed by the second expansion valve 71b to be brought into a cooled state, and flows into the heat exchanger 75 while being in the cooled state.

The compressor 72 compresses and heats the heat transfer medium flowing through the first heat exchange line 161. The compressor 72 of the first embodiment compresses the heat transfer medium, which is a mixture of a flow of the heat transfer medium that has passed through the first reactor 11a and a flow of the heat transfer medium that has passed through the second expansion valve 71b and the heat exchanger 75 via the second heat exchange line 162.

The heat exchanger 75 exchanges heat between a flow of the heat transfer medium compressed and heated by the compressor 72 and a flow of the heat transfer medium decompressed and cooled by the second expansion valve 71b after exchanging heat in the second reactor 11b. As a result, the flow of the heat transfer medium compressed by the compressor 72 is cooled by the heat exchanger 75 to a temperature (e.g., 80° C.) at which the adsorbent 12 does not deteriorate, before entering the second reactor 11b that performs the desorption process. The other flow of the heat transfer medium is heated by the heat exchanger 75, and exits from the heat exchanger 75 to return to the compressor 72 while being in the heated state.

The first reactor 11a is supplied with the heat transfer medium cooled by the first expansion valve 71a in order to cool the adsorbent 12. In the first reactor 11a, heat exchange between the adsorbent 12 and the heat transfer medium cools the adsorbent 12 and heats the heat transfer medium. The first reactor 11a functions as an evaporator that evaporates the heat transfer medium in a liquid state.

The second reactor 11b is supplied with the heat transfer medium heated by the compressor 72 in order to heat the adsorbent 12. In the second reactor 11b, heat exchange between the adsorbent 12 and the heat transfer medium heats the adsorbent 12 and cools the heat transfer medium. The second reactor 11b functions as a condenser that condenses the heat transfer medium in a vapor state.

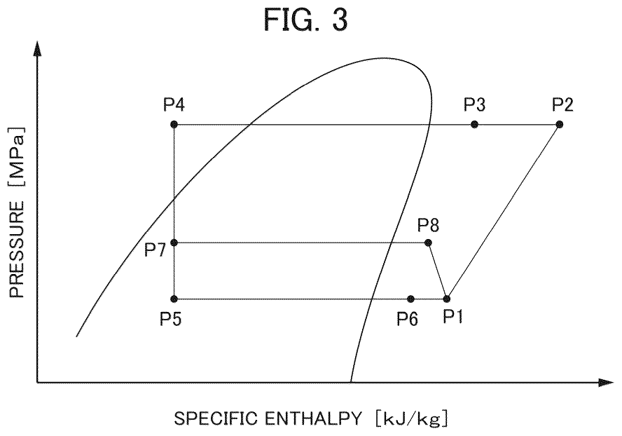

FIG. 3 is a Mollier diagram which illustrates heat transfer in the heat exchange device 70 of the carbon dioxide recovery apparatus 1 according to the first embodiment, and in which a specific enthalpy calculated from a temperature and a pressure of the heat transfer medium is plotted along the horizontal axis and the pressure is plotted along the vertical axis to represent a state of the heat transfer medium. In the first heat exchange line 161 illustrated in FIG. 2, a position before the inlet of the compressor 72 is denoted by P1, a position between the compressor 72 and the heat exchanger 75 is denoted by P2, a position between the heat exchanger 75 and the second reactor 11b is denoted by P3, a position of the portion where the second heat exchange line 162 branches is denoted by P4, a position between the first expansion valve 71a and the first reactor 11a is denoted by P5, and a position after the outlet of the first reactor 11a is denoted by P6. In the second heat exchange line 162, a position between the second expansion valve 71b and the heat exchanger 75 is defined by P7, and a position between the heat exchanger 75 and the confluence with the first heat exchange line 161 is defined by P8. A high-temperature and high-pressure superheated gas discharged from the compressor 72 is cooled by the heat exchanger 75 to be brought into a state in which the temperature has decreased from P2 to P3 in an excessive temperature rise gas region, and then, the superheated gas in this state loses heat to the adsorbent in the second reactor 11b (condenser) that is performing the desorption process so as to be cooled to P4. After being cooled to P4, a part of the heat transfer medium flows into the second heat exchange line 162 so that the pressure is reduced to an intermediate pressure at P7 by the second expansion valve 71b, exchanges heat with an excessive temperature rise gas having a high temperature and a high pressure and discharged from the compressor 72 so as to be brought into the state of P8, and thereafter, merges with a gas that is about to be suctioned into the compressor 72 at P1.

### Second Embodiment

Next, a configuration of a carbon dioxide recovery apparatus 1 according to a second embodiment, which has a flow path configuration different from that of the first embodiment, will be described. In the following description, components that are the same as or similar to those of the embodiment described above are denoted by the same reference signs, and detailed description thereof may be omitted.

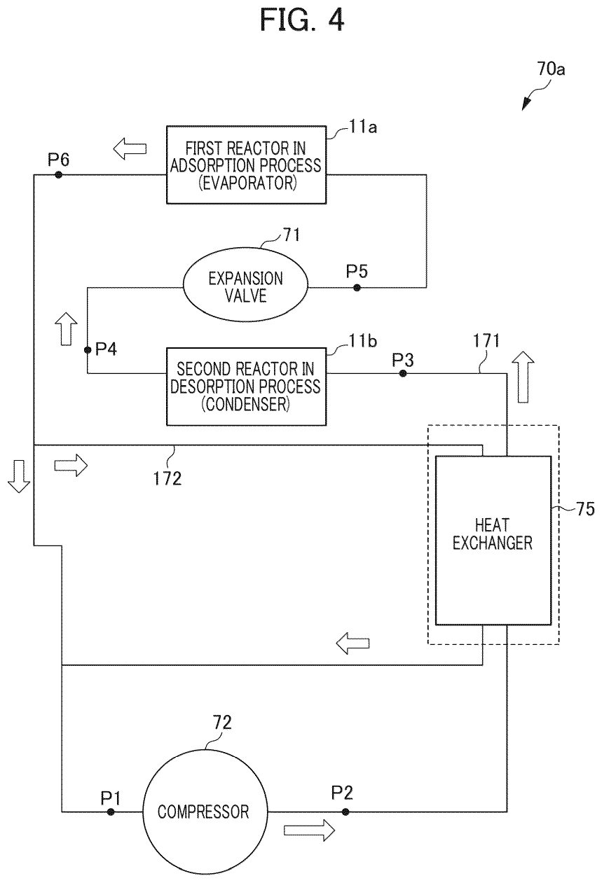

FIG. 4 is a circuit diagram illustrating a heat exchange device 70a of the carbon dioxide recovery apparatus 1 according to the second embodiment. It should be noted that the flow paths in FIG. 4 are also conceptual and indicate flows of a heat transfer medium, and the positions of a first reactor 11a and a second reactor 11b are switched in a state in which the first reactor 11a transitions to a desorption process and the second reactor 11b transitions to an adsorption process.

As illustrated in FIG. 4, the heat exchange device 70a includes a first heat exchange line 171, a second heat exchange line 172, an expansion valve 71, a compressor 72, a heat exchanger 75, the first reactor 11a, and the second reactor 11b.

The first heat exchange line 171 is a heat transfer medium flow path for supplying the heat transfer medium to the first reactor 11a and the second reactor 11b. The heat transfer medium is, for example, a fluorocarbon gas. On the first heat exchange line 171, the compressor 72, the heat exchanger 75, the second reactor 11b, the expansion valve 71, and the first reactor 11a are arranged in this order in an upstream-to-downstream direction. The first heat exchange line 171 is configured as a circulation flow path through which the heat transfer medium that has exited from an outlet of the compressor 72 finally returns to an inlet of the compressor 72.

The second heat exchange line 172 is a heat transfer medium flow path that branches off from a portion of the first heat exchange line 171 located downstream of the first reactor 11a and that connects to a portion of the first heat exchange line 171 located upstream of the compressor 72 via the heat exchanger 75.

The expansion valve 71 expands and decompresses the heat transfer medium that has been cooled by performing heating in the second reactor 11b.

The compressor 72 compresses and heats the heat transfer medium flowing through the first heat exchange line 171. The compressor 72 of the second embodiment compresses the heat transfer medium, which is a mixture of a flow of the heat transfer medium that has passed through the first reactor 11a and a flow of the heat transfer medium that has passed through the heat exchanger 75 via the second heat exchange line 172.

The heat exchanger 75 exchanges heat between a flow of the heat transfer medium that has been compressed and heated by the compressor 72 and a flow of the heat transfer medium that has exchanged heat in the first reactor 11a. As a result, the flow of the heat transfer medium compressed by the compressor 72 is cooled by the heat exchanger 75 to a temperature (e.g., 80° C.) at which the adsorbent 12 does not deteriorate, before entering the second reactor 11b that performs the desorption process. The other flow of the heat transfer medium that returns to the compressor 72 via the heat exchanger 75 is heated by way of heat exchange in the heat exchanger 75.

Also in the second embodiment, the first reactor 11a functions as an evaporator that evaporates the heat transfer medium in a liquid state, and the second reactor 11b functions as a condenser that condenses the heat transfer medium in a vapor state.

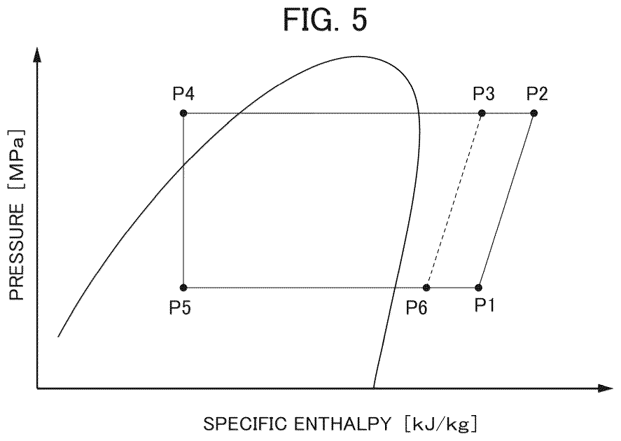

FIG. 5 is a Mollier diagram that illustrates heat transfer in the heat exchange device 70a of the carbon dioxide recovery apparatus 1 according to the second embodiment. In the first heat exchange line 171 illustrated in FIG. 4, a position before the inlet of the compressor 72 is denoted by P1, a position between the compressor 72 and the heat exchanger 75 is denoted by P2, a position between the heat exchanger 75 and the second reactor 11b is denoted by P3, a position between the second reactor 11b and the expansion valve 71 is denoted by P4, a position between the expansion valve 71 and the first reactor 11a is denoted by P5, and a position after the outlet of the first reactor 11a is denoted by P6. A part of the heat transfer medium that has exited from the first reactor 11a functioning as a heat exchanger and is in a low-temperature and low-pressure gas state is introduced into the second heat exchange line 172 and caused to exchange heat with a high-temperature and high-pressure gas discharged from the compressor 72 and corresponding to P2, whereby the high-temperature and high-pressure gas is cooled to P3 and then introduced into the second reactor 11b.

The carbon dioxide recovery apparatus 1 according to the embodiments described above includes: a plurality of reactors including a first reactor 11a and a second reactor 11b each of which includes an adsorbent 12 therein, the plurality of reactors being configured to perform an adsorption process in which a gas containing carbon dioxide is suctioned and the carbon dioxide is adsorbed on the adsorbent 12, and a desorption process in which surroundings of the adsorbent 12 are heated in a decompressed state whereby the carbon dioxide is desorbed from the adsorbent 12; an expansion valve 71 or a first expansion valve 71a that expands and decompresses a heat transfer medium to be supplied for a cooling purpose to the first reactor 11a that performs the adsorption process; a compressor 72 that compresses and pressurizes the heat transfer medium to be supplied for a purpose of heating to the second reactor 11b that performs the desorption process; and a heat exchanger 75 that cools the heat transfer medium compressed by the compressor 72. The heat transfer medium decompressed by the expansion valve 71 or the first expansion valve 71a is supplied to the first reactor 11a performing the adsorption process so that heat exchange between the heat transfer medium and the first reactor 11a cools the adsorbent 12 and heats the heat transfer medium. The heat transfer medium compressed by the compressor 72 is cooled by the heat exchanger 75 and then supplied to a portion which belongs to the second reactor 11b performing the desorption process and in which the adsorbent 12 is cooled so that heat exchange between the heat transfer medium and the second reactor 11b heats the adsorbent 12 and cools the heat transfer medium.

Due to the above feature, the adsorbent 12 in the second reactor 11b that is performing the desorption process can be directly heated by the heat transfer medium such as a chlorofluorocarbon gas compressed by the compressor 72, and the first reactor 11a that is performing the adsorption process can be cooled, without using a refrigerant such as a long life coolant (LLC). In addition, the heat transfer medium to be supplied to the inside of the second reactor 11b is cooled by the heat exchanger 75 functioning as a temperature adjuster such that the heat transfer is prevented from reaching a temperature at which the adsorbent 12 deteriorates, while being maintained in a good gas-liquid two-phase state at a temperature at which the adsorbent 12 can be appropriately heated. As described above, the configuration of the carbon dioxide recovery apparatus 1 of the above embodiments makes it possible to achieve both prevention or suppression of deterioration of the adsorbents 12 and improvement of energy efficiency.

In the embodiments, the heat exchanger 75 exchanges heat between the heat transfer medium that has been compressed by the compressor 72 and is yet to enter the second reactor 11b performing the desorption process and the heat transfer medium that has passed through the second reactor 11b performing the desorption process.

Due to this feature, the temperature of the heat transfer medium that is to flow into the second reactor 11b performing the desorption process can be adjusted by the heat exchanger 75 in the circuit of the heat exchange device 70 (heat exchange device 70a). Even when the first reactor 11a and the second reactor 11b have a configuration in which the heat exchanger 75 cannot be disposed, the temperature of the heat transfer medium compressed by the compressor 72 can be adjusted outside the first reactor 11a and the second reactor 11b to a temperature at which the adsorbent 12 does not deteriorate and can be appropriately heated.

In the first and second embodiments, the heat exchanger 75 exchanges heat outside the first reactor 11a and the second reactor 11b. However, the present invention is not limited to this configuration. The following describes an embodiment in which a heat exchanger 75 is not disposed outside the first reactor 11a and the second reactor 11b.

### Third Embodiment

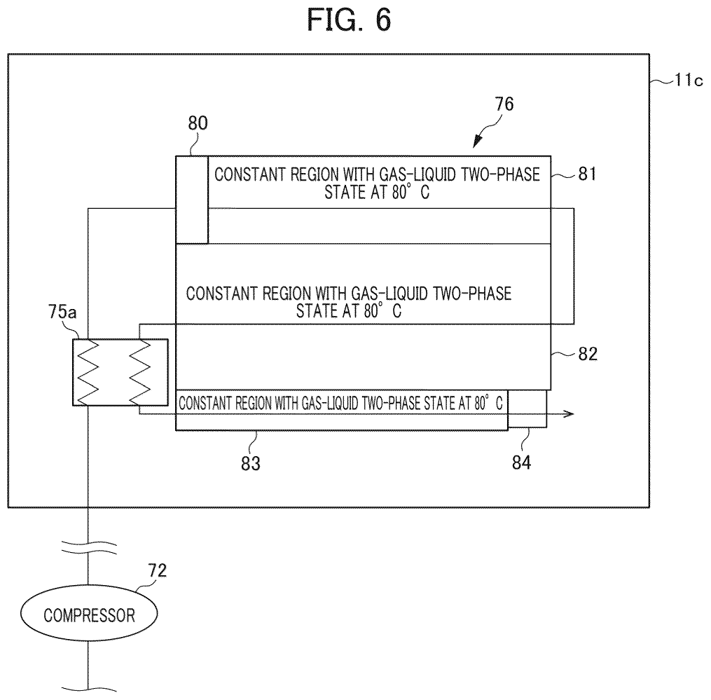

FIG. 6 is a schematic diagram illustrating a flow path 76 for a heat transfer medium in a reactor 11c of a carbon dioxide recovery apparatus 1 according to a third embodiment. It is assumed that the reactor 11c illustrated in FIG. 6 is performing a desorption process.

As illustrated in FIG. 6, a heat exchanger 75a that cools a heat transfer medium compressed by a compressor 72 is disposed inside or near the reactor 11c. The heat transfer medium, which is a high-temperature superheated gas compressed by the compressor 72, is cooled by the heat exchanger 75a. For example, the heat transfer medium is cooled from about 110° C. to about 82° C. Preferably, the heat exchanger 75a performs the heat exchange such that the gas temperature of the heat transfer medium is within the range of ±2° C. with respect to the saturation temperature.

The reactor 11c of the third embodiment includes an early stage portion 80, a flow path 76, and a later stage portion 84.

The early stage portion 80 includes an inlet of the flow path 76 for the heat transfer medium that exchanges heat with an adsorbent 12. By passing through the early stage portion 80, the heat transfer medium is cooled from about 92° C. to about 80° C.

The flow path 76 is a portion where the heat transfer medium exchanges heat with the adsorbent 12. The flow path 76 includes a plurality of passes, namely, a first pass 81, a second pass 82, and a third pass 83, and the total of the passes is an odd number. The first pass 81 and the second pass 82 are connected to each other in a hairpin shape, and the second pass 82 and the third pass 83 are also connected to each other in a hairpin shape. Thus, the flow path 76 is disposed in a layout in which the inlet side of the first pass 81 through which the heat transfer medium first flows into the flow path 76 is opposed to the outlet side of the third pass 83 through which the heat transfer medium comes out of the flow path 76.

The first pass 81 is a heat transfer medium flow path connected to the early stage portion 80. The heat transfer medium that is passing through the first pass 81 has a temperature of about 80° C. The inside of the first pass 81 constitutes a constant region having a temperature of about 80° C. at which the heat transfer medium is in a gas-liquid two-phase state.

The second pass 82 is a flow path through which the heat transfer medium that has passed through the first pass 81 flows. The inside of the second pass 82 also constitutes a constant region having a temperature of about 80° C. at which the heat transfer medium is in a gas-liquid two-phase state.

The heat transfer medium that has passed through the second pass 82 flows through the heat exchanger 75a and then flows into the third pass 83. The heat transfer medium, which has passed through the first pass 81 and the second pass 82, has a lowered temperature and is in a gas-liquid two-phase state the proportion of the gas phase of which is reduced (for example, to 10%). The present embodiment deals with this in the following manner. The heat transfer medium that has passed through the second pass 82 exchanges heat with the heat transfer medium that has a high temperature by having been compressed by the compressor 72 and is yet to flow into the inside of the reactor 11c, so that the temperature rises to about 80° C. and the proportion of the gas phase also increases (for example, to 30%). As a result, the heat transfer medium entering the third pass 83 can be brought into a further appropriate gas-liquid two-phase state.

The third pass 83 is the final flow path through which the heat transfer medium that has been heated by the heat exchanger 75a after passing through the second pass 82 flows. In the case where an odd total number of passes are provided as in the third embodiment, the heat transfer medium that has passed through the second pass 82 located immediately before the third pass 83, which is the final pass, exchanges heat. As described above, the heat transfer medium that has been cooled by passing through the first pass 81 and the second pass 82 increases in temperature in the heat exchanger 75a, and consequently, the inside of the third pass 83 also constitutes a constant region having a temperature of about 80° C. at which the heat transfer medium is in a gas-liquid two-phase state.

The later stage portion 84 includes an outlet of the flow path 76 through which the heat transfer medium that has passed through the third pass 83 exits to the outside of the reactor 11c. The later stage portion 84 constitutes a supercooled liquid phase region in which the heat transfer medium has a temperature of about 70° C.

In the third embodiment described above, the heat exchanger 75a exchanges heat between the heat transfer medium that has been compressed by the compressor 72 and is yet to enter the reactor 11c performing the desorption process and the heat transfer medium that is passing through the heat transfer medium flow path 76 inside the reactor 11c.

Due to this feature, the heat transfer medium compressed by the compressor 72 can be cooled by means of the heat transfer medium that has been cooled by exchanging heat with the adsorbent 12 in the reactor 11c. In addition, since the heat transfer medium in the reactor 11c is heated by exchanging heat in the heat exchanger 75a while passing through the flow path 76, it is possible to avoid a situation in which the temperature of the heat transfer medium is excessively lowered in the latter half of the flow path 76 and the balance of the gas and liquid phases is lost. Furthermore, a uniform temperature and a good gas-liquid two-phase state can be realized in the entire flow path 76 inside the reactor 11c.

In the third embodiment, the heat transfer medium flow path 76 includes an odd total number of passes, namely, the first pass 81, the second pass 82, and the third pass 83 that are connected to each other in a meandering pattern, and the heat exchanger 75a exchanges heat between the heat transfer medium that has passed through the second pass 82 located immediately before the final third pass 83 of the passes and the heat transfer medium that has been compressed by the compressor 72.

The above feature, in which the plurality of passes are connected to each other in a meandering pattern, makes it possible to ensure a sufficient flow path length for heat exchange with the adsorbent 12, while effectively utilizing the internal space of the reactor 11c. Furthermore, since the number of passes is an odd number, the position where heat exchange is performed before the final pass is on the inlet side of the flow path 76 of the reactor 11c. In a case where the heat exchange before the final pass is performed on the outlet side of the flow path 76, a pipe needs to be routed on the inlet side of the final pass. In contrast, according to the configuration of the present embodiment, it is sufficient to dispose the heat exchanger 75a adjacent to the hairpin portion before the final pass, whereby the routing of the pipe and the like can be simplified.

The reactor 11c of the third embodiment has a configuration including the plurality of passes, i.e., the first pass 81, the second pass 82, and the third pass 83, but the present invention is not limited to this configuration. The method of stacking a plurality of heat exchangers is not particularly limited, and it is possible to realize thermal connection with an appropriate structure in accordance with a layout. For example, the reactor may include one pass formed therein. This configuration will be described later.

The flow path 76 inside the reactor 11c may be managed using a computer such as a controller such that maintenance for replacing the adsorbent 12 in correspondence with positions is carried out at different intervals according to temperature grades. For example, the management may be performed such that a short maintenance interval is set for the early stage portion 80 and the first pass 81 through which the heat transfer medium having a high temperature passes, and a maintenance interval is set longer toward the downstream side, in the order of the second pass 82, the third pass 83, and the later stage portion 84.

Furthermore, in the third embodiment, materials having different desorption characteristics may be used for each of the passes. For example, the adsorbent 12 at a position corresponding to the early stage portion 80 and the first pass 81 may be filled with a material characterized in that the upper limit for heat resistance is high and a high temperature is required for desorption.

### Fourth Embodiment

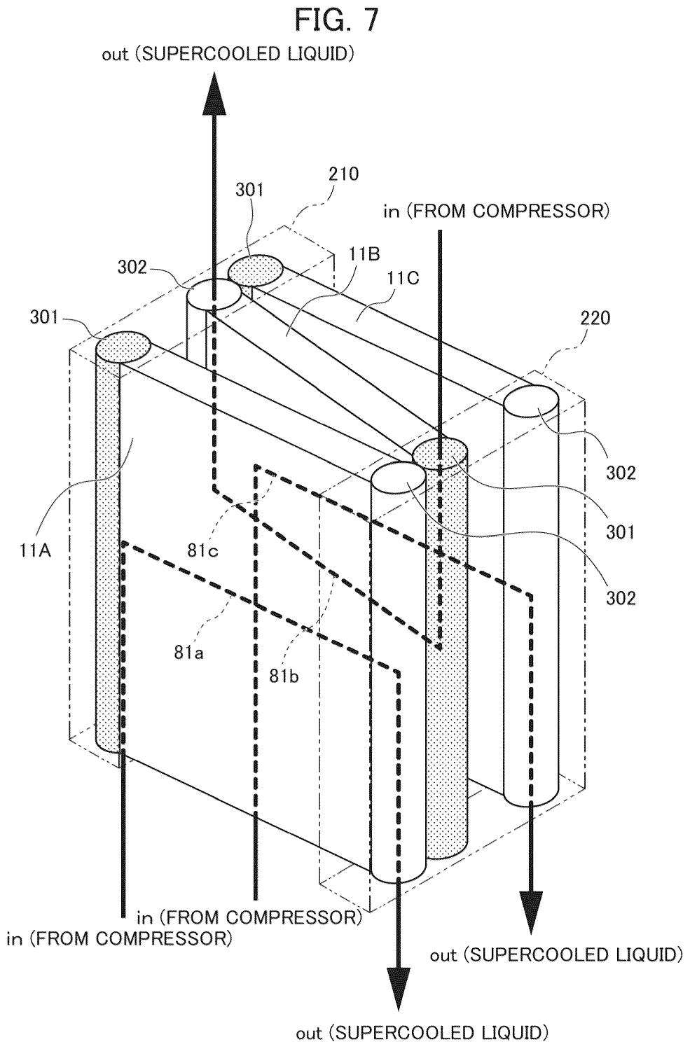

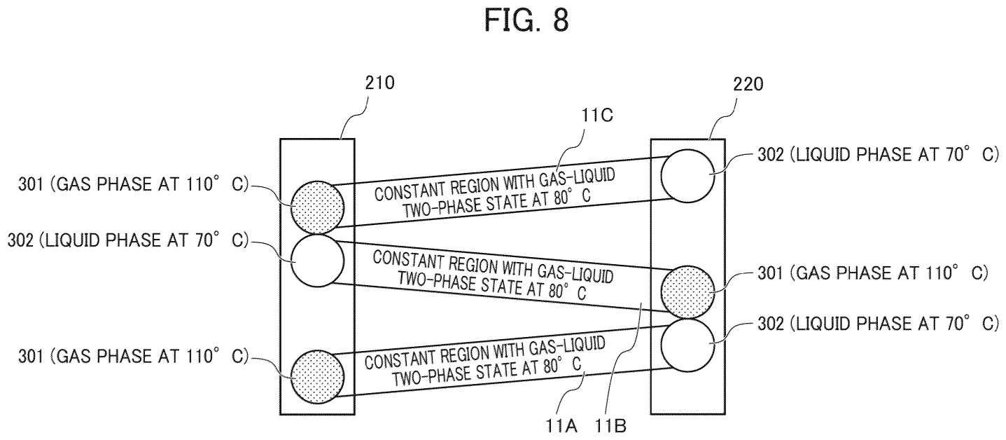

FIGS. 7 and 8 are diagrams illustrating a configuration example of a fourth embodiment in which a pass formed in each reactor has a single-path configuration. In the example illustrated in FIGS. 7 and 8, a first reactor 11A, a second reactor 11B, and a third reactor 11C are disposed adjacent to each other. The first reactor 11A, the second reactor 11B, and the third reactor 11C respectively include flow paths 81a, 81b, and 81c, and each have the one-pass structure in which the flow path 81a, 81b, or 81c extends in one direction from one side toward the other side without bending in a hairpin shape.

Headers 210 and 220 are provided on the heat transfer medium inlet sides and the heat transfer medium outlet sides of the reactors. A plurality of supply lines 301 and a plurality of discharge lines 302 are disposed adjacent to each other in the headers 210 and 220. The supply lines 301 are respectively connected to the first reactor 11A, the second reactor 11B, and the third reactor 11C, and supply a high-temperature heat transfer medium from a compressor to the reactors. The discharge lines 302 are respectively connected to the first reactor 11A, the second reactor 11B, and the third reactor 11C, and discharge the heat transfer medium cooled in the reactors.

The first reactor 11A and the third reactor 11C are arranged so that the directions in which the supply lines 301 and the discharge lines 302 of the first and third reactors 11A and 11C are provided are opposite to those of the second reactor 11B. Specifically, in the header 210, the discharge line 302 of the second reactor 11B is located between the supply line 301 of the first reactor 11A and the supply line 301 of the third reactor 11C. In the header 220, the supply line 301 of the second reactor 11B is located between the discharge line 302 of the first reactor 11A and the discharge line 302 of the third reactor 11C. Furthermore, the supply lines 301 and the discharge lines 302 are in thermal contact with each other so as to function as heat exchangers in the headers 210 and 220. Due to this configuration, the excessive temperature rise gas (heat transfer medium) on the upstream side of the reactors 11A to 11C can be cooled and supplied to the reactors 11A to 11C, and the temperature of the excessive temperature rise gas flowing into the heat exchangers (reactors 11A to 11C) can be lowered.

It should be noted that the above-described embodiments and modifications are not intended to limit the present invention. The effects described in the above-described embodiments are merely examples of favorable effects, and the effects of the present invention are not limited to those of the above-described embodiments.

### EXPLANATION OF REFERENCE NUMERALS

1: Carbon dioxide recovery apparatus
11a: First reactor
11b: Second reactor
11c: Reactor
11A: First reactor
11B: Second reactor
11C: Third reactor
12: Adsorbent
70: Heat exchange device
70a: Heat exchange device
71: Expansion valve
71a: First expansion valve
71b: Second expansion valve
72: Compressor
75: Heat exchanger
75a: Heat exchanger
76: Flow path
81: First pass
82: Second pass
83: Third pass

What is claimed is:

1. A carbon dioxide recovery apparatus comprising:
a plurality of reactors each of which includes an adsorbent therein, the plurality of reactors being configured to perform an adsorption process in which a gas containing carbon dioxide is suctioned and the carbon dioxide is adsorbed on the adsorbent, and a desorption process in which surroundings of the adsorbent are heated in a decompressed state whereby the carbon dioxide is desorbed from the adsorbent;
an expansion valve that expands and decompresses a heat transfer medium to be supplied for a cooling purpose to one of the plurality of reactors that performs the adsorption process;
a compressor that compresses and pressurizes the heat transfer medium to be supplied for a heating process to an other of the plurality of reactors that performs the desorption process; and
a heat exchanger that cools the heat transfer medium compressed by the compressor,
wherein the heat transfer medium decompressed by the expansion valve is supplied to the one of the plurality of reactors that performs the adsorption process so that heat exchange between the heat transfer medium and the one of the plurality of the reactors cools the adsorbent and heats the heat transfer medium, and
wherein the heat transfer medium compressed by the compressor is cooled by the heat exchanger and then supplied to a portion which belongs to the other of the plurality of reactors that performs the desorption process and in which the adsorbent is cooled so that heat exchange between the heat transfer medium and the other of the plurality of reactors heats the adsorbent and cools the heat transfer medium.

2. The carbon dioxide recovery apparatus according to claim 1, wherein
the heat exchanger exchanges heat between the heat transfer medium that has been compressed by the compressor and is yet to enter the other of the plurality of reactors that performs the desorption process, and
the heat transfer medium that has passed through the other of the plurality of reactors that performs the desorption process.

3. The carbon dioxide recovery apparatus according to claim 1, wherein
the heat exchanger exchanges heat between the heat transfer medium that has been compressed by the compressor and is yet to enter the other of the plurality of reactors that performs the desorption process, and
the heat transfer medium that is passing through a flow path for the heat transfer medium inside the reactor.

4. The carbon dioxide recovery apparatus according to claim 3, wherein
the flow path for the heat transfer medium inside the reactor includes an odd total number of passes connected to each other in a meandering pattern, and
the heat exchanger exchanges heat between the heat transfer medium that has passed through one of the passes that is located immediately before a final pass of the passes, and the heat transfer medium that has been compressed by the compressor.
